(19) United States
(12) Patent Application Publication
(10) Pub. No.: US 2009/0255364 A1
(43) Pub. Date: Oct. 15, 2009

(54) PARALLEL MECHANISM

(75) Inventors: Tatsuhiko NISHIDA, Kyoto-shi (JP); Hideaki NAKANISHI, Kyoto-shi (JP); Manabu YAMASHITA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/416,241

(22) Filed: Apr. 1, 2009

(30) Foreign Application Priority Data
Apr. 10, 2008 (JP) 2008-102966

(51) Int. Cl. B25J 18/00

(52) U.S. Cl. 74/490.07

(57) ABSTRACT

A parallel mechanism has a plurality of arms. Each of the arms has a ball joint. The ball joint includes a ball stud with a shaft portion and ball-shaped head, and a socket swingably and pivotally movably holding the ball-shaped head of the ball stud. The socket includes a semispherical recess portion holding the ball-shaped head from a top portion to an equator thereof, and an extending portion which is smoothly continuous with the semispherical recess portion and which extends from the equator of the ball-shaped head to the shaft portion side. The inner diameter of an opening in the extending portion is equal to or larger than the diameter of the ball-shaped head.

### CROSS-REFERENCE TO RELATED APPLICATIONS

This application claims priority under 35 U.S.C. 119 to Japanese Patent Application No. 2008-102966, filed on Apr. 10, 2008, which application is hereby incorporated by reference in its entirety.

### BACKGROUND OF THE INVENTION

1. Field of the Invention

The present invention relates to a parallel mechanism, and in particular, to a parallel mechanism including arms coupled together via a ball joint.

2. Description of Related Art

A conventionally known parallel mechanism includes a base portion that is a support base and a bracket with an end effector attached thereto coupled together in parallel via a plurality of arms. In the parallel mechanism, electric motors are arranged in parallel. Furthermore, a plurality of arms coupled to the respective motors ultimately operate one bracket.

In the parallel mechanism, each of the arms is composed of a link and rods. The link and each of the rods are coupled together via ball joints. The rods are swingable around the ball joints as a support point in a three-dimensional direction with respect to the link. The tip of each of the rods is coupled to a bracket via the ball joint. This structure allows the link to swing around the ball joints as a support point in the three-dimensional direction with respect to the brackets. Furthermore, in the parallel mechanism, a ball of each of the ball joints is rotatably held with one half side of the ball exposed from a socket, and the two rods are coupled together via a spring. This prevents the ball of the ball joint from coming loose from the socket during swinging of the arm, consequently the swing angle (movable range) of the arm is increased.

In the parallel mechanism, the ball of the ball joint and the socket are held by the tensile force of a spring. However, one half side of the ball in the ball joint is exposed from the socket. Thus, when the ball joint is subjected to a load exceeding the tensile force of the spring, the ball may come loose from the socket. This problem is more significant at a position closer to the outer edge of the operating range of the parallel mechanism. In contrast, an increase in the tensile force of the spring increases the sliding resistance of the ball joint. This may increase a load during a high-speed operation and the level of the wear of the ball joint portion. On the other hand, when the ball of the ball joint is covered with the socket along the spherical surface of the ball up to the base end of the ball joint, the maintainability of the parallel mechanism in disassembly maintenance or the like is degraded.

An external force exerted on an end effector (bracket) during operation of the parallel mechanism is decomposed into axial loads acting on the respective rods. When an edge portion of the socket engages with the ball but reaches only a position that is closer to the tip of the ball than the equator thereof, a repulsion force acts on the socket in a direction opposite to that of the tensile force of the spring. If the repulsion force is stronger than the tensile force, the ball in the ball joint may come loose from the socket.

### SUMMARY OF THE INVENTION

Preferred embodiments of the present invention described below solve the above-described problems in the prior art and inhibit the ball joints swingably coupling the arms and the like together from coming loose without degrading the maintainability.

A parallel mechanism according to a preferred embodiment of the present invention includes a base portion and a bracket coupled together in parallel via a plurality of arms and is configured as follows. Each of the plurality of arms includes a first link, one end of which is coupled to an actuator attached to the base portion, a second link having paired rods and via which the other end of the first link and a bracket are coupled together, a first ball joint via which one end of each of the paired rods of the second link and the other end of the first link are swingably coupled together, a second ball joint via which the other end of each of the paired rods and the bracket are swingably coupled together, and a tensile member biasing the paired rods in a direction in which the rods pull each other. At least one of the first ball joint and the second ball joint has a ball stud including a shaft portion and a ball-shaped head, and a socket swingably and pivotally movably holding the ball-shaped head of the ball stud. The socket includes a semispherical recess portion holding the ball-shaped head from a top portion to an equator thereof, and an extending portion which is smoothly continuous with the semispherical recess portion and which extends from the equator of the ball-shaped head to the shaft portion side. The socket is configured such that an inner diameter of an opening in the extending portion is equal to or larger than a diameter of the ball-shaped head.

According to a preferred embodiment of the present invention, the parallel mechanism includes the extending portion extending continuously and smoothly from the semispherical recess portion to the socket defining the first ball joint and/or the second ball joint. This enables a reaction force acting on the socket (a reaction force reacting to a load imposed in the axial direction of the rod) to be perpendicularly received, inhibiting a possible repulsion (a partial force of the reaction force with respect to the axial direction of the shaft portion) acting in a direction in which the socket comes loose. The ball-shaped head of the ball stud can be inhibited from coming loose from the socket. On the other hand, the extending portion is configured such that the inner diameter of the ball-shaped head of the ball stud is equal to or larger than the diameter of the ball-shaped head. Thus, for example, for disassembly maintenance, the ball stud can be removed from the socket by pulling the socket outward along the axial direction of the shaft portion of the ball stud with a force stronger than the tensile force of the tensile member. As a result, the ball joints can be inhibited from coming loose without degrading the maintainability.

Here, preferably, the paired rods are arranged such that central axes of the rods are parallel or substantially parallel to each other. The extending portion is substantially cylindrically shaped. A central axis of the extending portion extends parallel or substantially parallel to a plane defined by the respective central axes of the paired rods and substantially perpendicularly to the respective central axes of the paired rods.

In this arrangement, even if an excessive load is placed in the direction of the central axes of the rods in conjunction with motion of the parallel mechanism, the ball joints can be reliably inhibited from coming loose.

Moreover, length of the extending portion is preferably set according to diameter of the ball-shaped head.

In this arrangement, the length of the extending portion can be appropriately set. Thus, the ball joints can be appropriately inhibited from coming loose while ensuring the maintainability and the proper movable range of the parallel mechanism.

Furthermore, the length of the extending portion is preferably set according to overall length of the tensile member.

In this arrangement, the length of the extending portion can be appropriately set. Thus, the ball joints can be inhibited from coming loose while ensuring the maintainability of the parallel mechanism.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view showing the general configuration of a parallel mechanism according to a preferred embodiment of the present invention.

FIG. 2 is a diagram showing the parallel mechanism as viewed from the direction of arrow Al in FIG. 1.

FIG. 3 is a sectional view of a ball joint used in the parallel mechanism according to a preferred embodiment of the present invention.

FIG. 4 is a sectional view of a ball joint according to a comparative example.

FIG. 5 is a diagram showing measurement results for an example of a preferred embodiment of the present invention and a comparative example.

### DETAILED DESCRIPTION OF PREFERRED EMBODIMENTS

Preferred embodiments of the present invention will be described below in detail with reference to the drawings. In the drawings, the same elements are denoted by the same reference numerals, and duplicate descriptions are omitted.

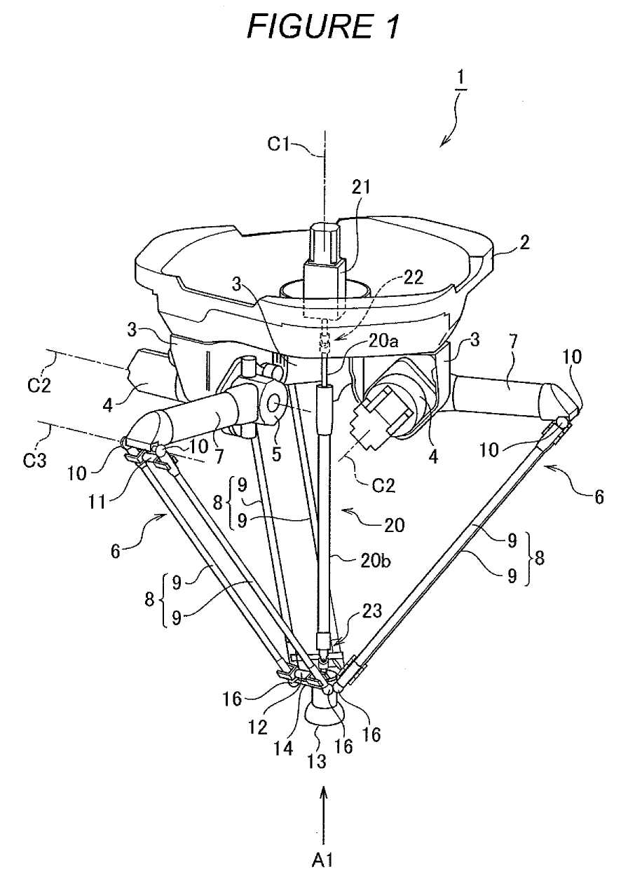

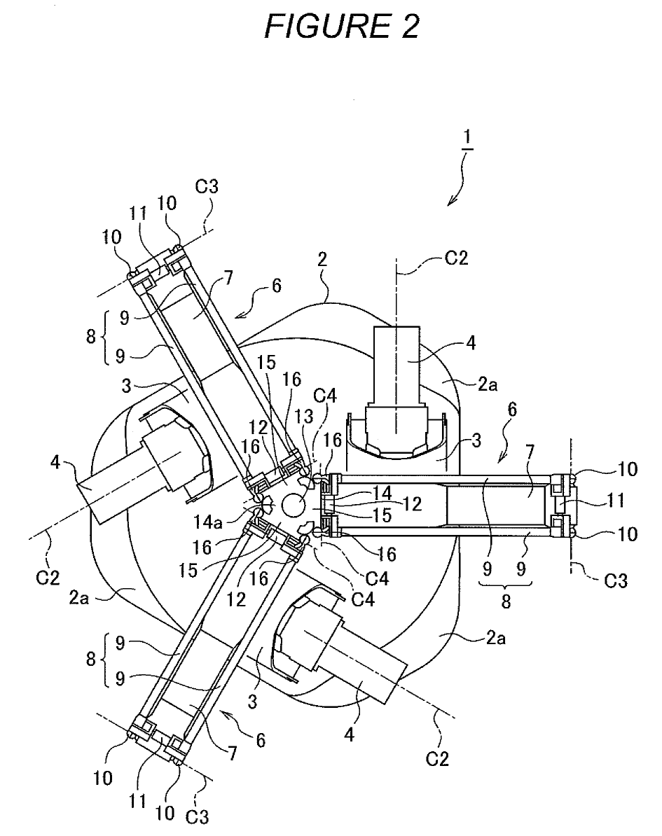

First, the general configuration of a parallel mechanism according to a preferred embodiment will be described with reference to FIGS. 1 and 2. FIG. 1 is a perspective view showing the general configuration of the parallel mechanism 1 according to a preferred embodiment of the present invention. FIG. 2 is a diagram showing the parallel mechanism 1 as viewed from the direction of arrow A1 in FIG. 1.

The parallel mechanism 1 has a base portion at the top thereof. The parallel mechanism 1 is supported by fixing a flat mounting surface 2a of the base portion 2 arranged on the bottom surface side thereof, to, for example, a flat ceiling. On the other hand, three support members 3 are provided on the bottom surface side of the base portion 2. An electric motor 4 is supported in each of the support members 3. The electric motor 4 is supported such that the axis C2 of a motor shaft is parallel or substantially parallel (that is, horizontal) to the mounting surface 2a of the base portion 2. The support members 3 are separated from one another by equal angles (approximately 120 degrees, for example) around the vertical axis C1 of the base portion 2. The electric motors 4 are also separated from one another by equal angles (approximately 120 degrees, for example) around the vertical axis C1 of the base portion 2 (see FIG. 2).

A substantially hexagonal cylindrical arm support member 5 is fixed to an output shaft of each of the electric motors 4 coaxially with the axis C2. The arm support member 5 is rotated around the axis C2 by driving the electric motor 4. Each of the electric motors 4 is connected to an electronic control device (not shown in the drawings). Rotation of the output shaft of the electric motor 4 is controlled by the electronic control device.

The parallel mechanism 1 preferably has three arm main bodies 6. Each of the arm main bodies 6 includes a first arm 7 and a second arm 8. Here, the first arm 7 corresponds to a first link. The second arm 8 corresponds to a second link. The first arm 7 is preferably an elongated, hollow cylindrical member formed of, for example, carbon fiber, for example. The base end of the first arm 7 is attached to a side surface of the arm support member 5. The first arm 7 is fixed so that the axis of the first arm 7 is perpendicular or substantially perpendicular to the axis C2.

The base end of the second arm 8 is coupled to the free end of the first arm 7 so that the second arm 8 is swingable around the free end of the first arm 7. The second arm 8 includes paired elongated rods 9. The paired rods 9 are arranged parallel or substantially parallel to each other in the longitudinal direction thereof. Each of the rods 9 is also an elongated, hollow cylindrical member formed of, for example, carbon fiber. The base ends of the rods 9 are rotatably coupled to the free end of the first arm 7 via paired ball joints 10. An axis C3 connecting the rotational centers of the ball joints 10 at the base ends of the rods 9 is located parallel or substantially parallel to the axis C2 of the electric motor 4.

Furthermore, at the base end of the second arm 8, one rod 9 and the other rod 9 are coupled together via a coupling member 11. At the free end of the second arm 8, one rod 9 and the other rod 9 are coupled together via a coupling member 12. Each of the coupling members 11, 12 has, for example, a tensile coil spring as a biasing member to bias the paired rods 9 in a direction in which the rods 9 pull each other. That is, the coupling members 11, 12 function as a tensile member. The coupling members 11, 12 may have different structures but preferably have the same structure in terms of reduced costs. Each of the coupling members 11, 12 has the function of preventing the rods 9 from rotating around respective axes parallel to the longitudinal direction of the rods 9.

Furthermore, the parallel mechanism 1 has a bracket 14 to which an end effector portion (tool) 13 is pivotally movably attached. The bracket 14 is a substantially equilateral triangular, plate-shaped member. The bracket 14 is held by three arm main bodies 6 so that a mounting surface 14a (the bottom surface of the bracket 14 in FIG. 1) of the bracket 14 to which the end effector portion 13 is attached is parallel or substantially parallel (that is, horizontal) to the mounting surface 2a of the base portion 2.

A mounting piece 15 is arranged on each side of the bracket 14. The mounting piece 15 is coupled to the free end (the free ends of the pared rods 9 defining the second arm 8) of the corresponding arm main body 6. The bracket 14 thus swings with respect to the corresponding arm main body 6 around the free end of the arm main body 6. Specifically, an end of each of the mounting pieces 15 of the bracket 14 is coupled to the free ends of the corresponding rods 9 via ball joints 16. An axis C4 (see FIG. 2) connecting the paired ball joints 16 together is also parallel to the axis C2 of each of the electric motors 4. Thus, the bracket 14 can swing with respect to each of the arm main bodies 6 around the horizontal axis C4. The substantially equilateral triangular bracket 14 is supported by the three arm main bodies 6 so as to be swingable at all the sides thereof around the horizontal axis C4.

The distance between the paired ball joints 10, located at the coupling portions between the first arm 7 and the second arm 8, preferably is set equal to the distance between the paired ball joints 16, located at the coupling portions between the bracket 14 and the rods 9 of the second arm 8. Thus, as described above, the paired rods 9 defining the second arm 8 are arranged parallel or substantially parallel to each other all over the length thereof in the longitudinal direction thereof. All of the axes C2, C3, C4 are parallel or substantially parallel to the mounting surface 2a of the base portion 2. Thus, regardless of however the first arm 7, the second arm 8, and the bracket 14 swing around the axes C2, C3, C4, respectively, the parallel relationship is maintained between the mounting surface 14a of the bracket 14 to which the end effector portion 13 is attached and the mounting surface 2a of the base portion 2.

In response to instructions from the electronic control device, the rotating position of the arm support member 5 fixed to the output shaft of each of the electric motors 4 is controlled to control the position of the free end of the corresponding first arm 7. The position of the free end of each of the second arms 8 follows the controlled position of the free end of the corresponding first arm 7. This determines the position of the mounting surface 14a of the bracket 14 to which the end effector portion 13 is attached. At this time, as described above, the bracket 14 moves with the horizontal posture thereof maintained.

Furthermore, the parallel mechanism 1 has a turning shaft rod 20 located in the center thereof and extending in the vertical direction, and an electric motor 21 that rotates the turning rod 20. The electric motor 21 is fixed to the base portion 2 with an output shaft thereof directed downward in the vertical direction. One end of the turning shaft rod 20 is coupled to the output shaft of the electric motor 21 via a universal joint 22. On the other hand, the other end of the turning shaft rod 20 is connected to the end effector portion 13 via the universal joint 23. The turning shaft rod 20 is realized by a rod 20a and a cylinder 20b, and configured to be telescopic. Moreover, the turning shaft rod 20 is preferably a ball spline, and thus enables rotation of the rod 20a to be transmitted to the cylinder 20a. Since the universal joints 22, 23 are provided at the respective ends of the turning shaft rod 20, even though the bracket 14 is drivingly moved to a predetermined upward, downward, forward, backward, rightward, or leftward position by the three electric motors 4, the turning shaft rod 20 can move following the predetermined position. The electric motor 21 is also connected to the above-described electronic control device. Rotation of the output shaft of the electric motor 21 is controlled by the electronic control device to control the rotating position of the end effector portion 13.

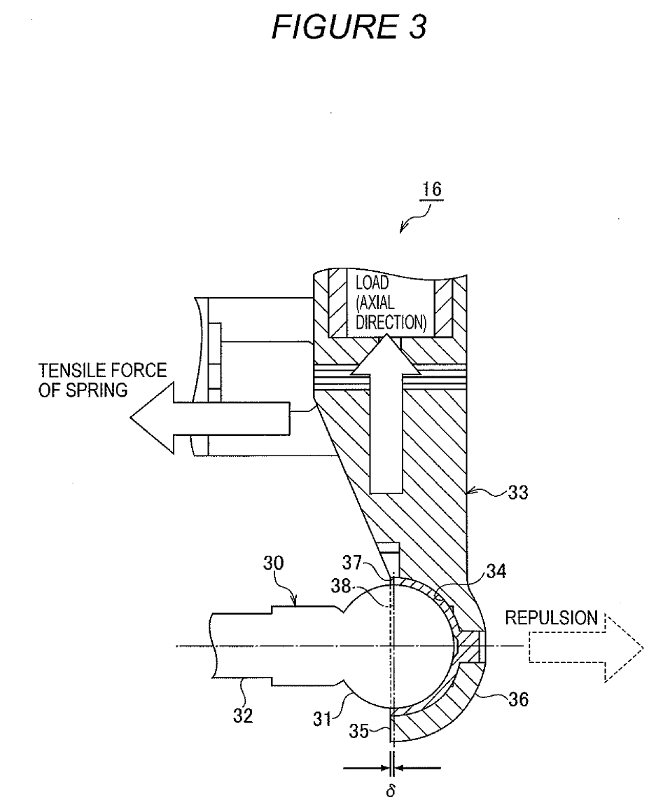

Now, the structure of the ball joint 16, via which the free end of the rod 9 and the bracket are swingably coupled together, will be described with reference to FIG. 3. Here, FIG. 3 is a sectional view of the ball joint 16. The structure of the ball joint 16 is the same as or similar to that of the ball joint 10, via which the base end of the rod 9 and the free end of the first arm 7 are coupled together. Thus, here, the description of the structure of the ball joint 10 is omitted.

The ball joint 16 has a ball stud 30 made of, for example, steel, a rod 33 serving as a socket member, and a resin cup 37 serving as a receiving portion.

The ball stud portion 30 has a ball-shaped head 31 with a spherical outer peripheral surface integrally arranged at a tip portion thereof. Furthermore, a shaft portion 32 is integrally projected from the ball-shaped head 31 of the ball stud 30.

The rod 33 includes a socket 36 arranged at one end thereof and having a semispherical recess portion 34, and a ring-shaped extending portion 35; the semispherical recess portion 34 has an inner peripheral surface corresponding substantially to the spherical outer peripheral surface of the ball-shaped head 31, and the extending portion 35 is smoothly continuous with the semispherical recess portion 34. The semispherical recess portion 34, arranged in the socket 36, is formed to hold the ball-shaped head 31 from the tip portion to an equator 38 thereof in a stationary condition shown in FIG. 3. The equator 38 of the ball-shaped head 31 refers to a nodal line between the ball-shaped head 31 and a plane that is perpendicular to the central axis of the ball stud 30, the nodal line is defined when the plane is located at a position where the diameter of the ball-shaped head 31 is largest.

The extending portion 35 is substantially cylindrically shaped. The extending portion 35 is arranged to extend parallel or substantially parallel to a plane defined by the central axes of the paired rods 9 (rods 33, 33) and perpendicularly or substantially perpendicularly to the central axes of the paired rods 9 (rods 33). The extending portion 35 is formed to have an inner diameter equal to or slightly larger than the diameter of the ball-shaped head 31. Furthermore, in the present preferred embodiment, the diameter of the ball-shaped head 31 is set to about 16 mm, and the length δ of the extending portion 35 is set to about 0.5 mm, for example. The length δ of the extending portion 35 is preferably set according to use conditions, for example, the diameter of the ball-shaped head 31, the overall length of the coupling member 12 (or the adhesion length of the tensile coil spring, included in the coupling member 12), and a load taken into account.

The resin cup 37 is preferably interposed between both the semispherical recess portion 34 and the extending portion 35, arranged in the socket 36, and the ball-shaped head 31 of the ball stud 30, held in the socket 36. The resin cup 37 is installed to tightly contact with the inner surfaces of the semispherical recess portion 34 and the extending portion 35. A suitable resin material forming the resin cup 37 is, for example, a fluorine resin, which offers low frictional properties. Furthermore, any resin other than the fluorine-containing resin which offers high sliding properties, for example, polyacetal (POM) or polyether ketone (PEEK), may be suitably used.

The ball-shaped head 31 is accommodated and held in the socket 36 to swingably and pivotally movably couple the ball stud 30 to the socket 36. Furthermore, the mounting piece 15 of the bracket 14 is fixed to the shaft portion 32 of the ball stud 30. On the other hand, the tip portion of the rod 9 is inserted into the rod 33 to fix the rods 33 and 9 so as to prevent the rods 33 and 9 from rotating with respect to each other. The other rod 9 paired with the above-described rod 9 and defining the second arm 8 is similarly coupled to the mounting piece 15 of the bracket 14 via the ball joint 16. Thus, the second arm 8 and the bracket 14 are swingably coupled to each other.

An external force exerted on the end effector portion 13 (bracket 14) during operation of the parallel mechanism 1 is decomposed into axial loads acting on the respective rods 9. In the above-described configuration, when a load is imposed on the rod 9 in the axial direction thereof, a reaction force acting on the socket 36 (reaction force reacting to the load acting in the axial direction of the rod 9) is perpendicularly received by the semispherical recess portion 34, formed in the socket 36, and the extending portion 35, which is smoothly continuous with the semispherical recess portion 34. This inhibits a possible repulsion force (partial force of a reaction force with respect to the axial direction of the shaft portion 32) acting in a direction in which the socket 36 comes loose.

According to the present preferred embodiment, the extending portion 35, which is smoothly continuous with the semispherical recess portion 34, is arranged in the socket 36, defining the ball joint 16. Thus, the reaction force acting on the socket 36 can be perpendicularly received, inhibiting the possible repulsion acting in the direction in which the socket 36 comes loose. Thus, the ball-shaped head 31 of the ball stud 30 can be inhibited from coming loose from the socket 36. On the other hand, the extending portion 35 is arranged such that the inner diameter of the opening in the extending portion 35 is equal to or slightly larger than the diameter of the ball-shaped head 31. Thus, for example, for disassembly maintenance, the ball stud 30 can be removed from the socket 36 by pulling the socket 36 outward along the axial direction of the shaft portion of the ball stud 30 with a force stronger than the tensile force of the coupling member 12. As a result, the ball joints 16 can be inhibited from coming loose without degrading the maintainability.

In particular, in the present preferred embodiment, the extending portion 35 is substantially cylindrically shaped. The central axis of the extending portion 35 extends parallel or substantially parallel to a plane defined by the central axes of the paired rods 9 (rods 33) and substantially perpendicularly to the central axes of the paired rods 9 (rods 33). Thus, even if an excessive load is placed in the direction of the central axes of the rods 9 (rods 33) in conjunction with motion of the parallel mechanism 1, the ball joints 16 can be reliably inhibited from coming loose.

Furthermore, according to the present preferred embodiment, the length δ of the extending portion 35 is preferably set according to use conditions, for example, the diameter of the ball-shaped head 31, the overall length of the coupling member 12, and the load taken into account. Thus, the length δ of the extending portion 35 can be appropriately set. Consequently, the ball joints 16 can be inhibited from coming loose while ensuring the maintainability and the proper movable range of the parallel mechanism 1.

The capability of inhibiting the ball joints from coming loose according to the present preferred embodiment will be specifically demonstrated with reference to an example and a comparative example of the present preferred embodiment. In the example and the comparative example of the present preferred embodiment, a load (N) was varied which was imposed, in a −Y direction, on the position of the end effector portion, corresponding to coordinates (X, Y, Z) of (450, −260, 860) (mm). Then, the load N at which the any ball joint came loose was measured using a load cell (see the measurement method section of FIG. 6).

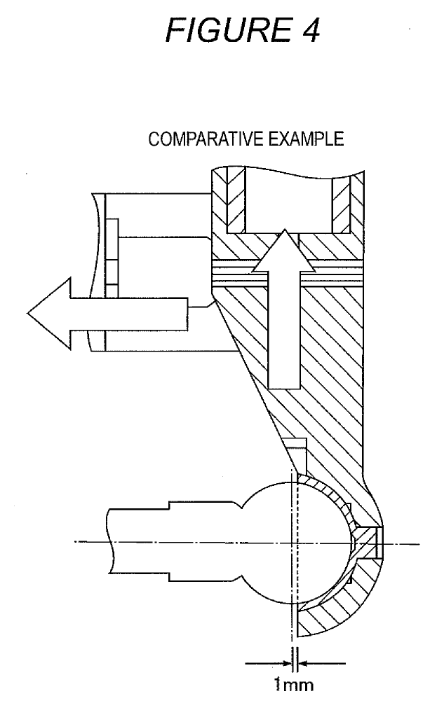

In the example, ball joints having the same structure as that of the ball joints 16 were used. On the other hand, in the comparative example, ball joints (see FIG. 4) were used which had no extending portion arranged therein and in which the end of the opening of the semispherical recess portion was positioned about 1 mm away from the equator toward the tip of the ball-shaped head in the stationary state shown in FIG. 4

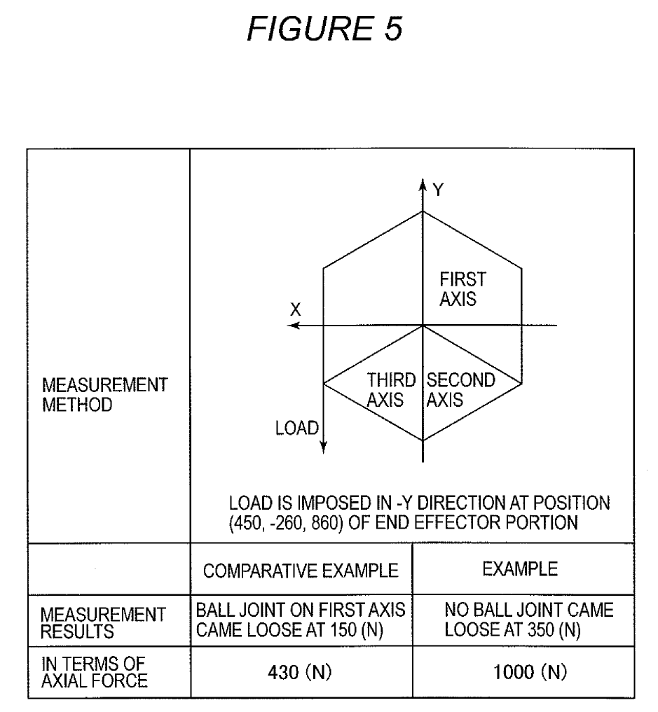

Measurement results are shown in FIG. 5. As seen in FIG. 5, in the comparative example, the ball joint on a first axis came loose when a load of 150 (N) (430 (N) in terms of axial force) was imposed. On the other hand, in the example, no ball joint came loose even when a load of 350 (N) (1,000 (N) in terms of axial force) was imposed. Thus, the effectiveness of the present preferred embodiment was confirmed.

Preferred embodiments of the present invention have been described. However, the present invention is not limited to the above-described embodiments. Many variations may be made to the above-described embodiments. For example, in the above-described embodiments, the extending portion 35 preferably is substantially cylindrically shaped. However, the shape of the extending portion is not limited to the substantial cylindrical shape. For example, the extending portion may be formed to appear trapezoidal as viewed from the side surface thereof.

In the above-described embodiments, the ball joint 16, via which the free end of the rod 9 and the bracket 14 are swingably coupled together, has the same structure as that of the ball joint 10, via which the base end of the rod 9 and the free end of the first arm 7 are coupled together. However, for example, with the loads imposed on the ball joints 16 and 10, respectively, taken into account, the ball joints 16 and 10 may have different structures.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that falls within the true spirit and scope of the present invention.

What is claimed is:

1. A parallel mechanism comprising:
a base portion to which actuators are attached;
a bracket coupled substantially in parallel with the base portion;
a plurality of arms via which the base portion and the bracket are coupled together; wherein
each of the plurality of arms includes a first link, one end of which is coupled to the actuator, a second link having paired rods and via which another end of the first link and the bracket are coupled together, a first ball joint via which one end of each of the paired rods of the second link and the another end of the first link are swingably coupled together, a second ball joint via which another end of each of the paired rods and the bracket are swingably coupled together, and a tensile member arranged to bias the paired rods in a direction in which the rods pull each other;
at least one of the first ball joint and second ball joint has a ball stud including a shaft portion and a ball-shaped head, and a socket swingably and pivotally movably holding the ball head of the ball stud;
the socket including a semispherical recess portion holding the ball-shaped head from a top portion to an equator thereof, and an extending portion which is smoothly continuous with the semispherical recess portion and which extends from the equator of the ball-shaped head to the shaft portion side; and
the socket is arranged such that an inner diameter of an opening in the extending portion is equal to or larger than a diameter of the ball-shaped head.

2. The parallel mechanism according to claim 1, wherein
the paired rods are arranged such that central axes of the rods are substantially parallel to each other; and
the extending portion is substantially cylindrically shaped, and a central axis of the extending portion extends substantially parallel to a plane defined by the respective central axes of the paired rods and substantially perpendicularly to the respective central axes of the paired rods.

3. The parallel mechanism according to claim 2, wherein the length of the extending portion is set according to a diameter of the ball-shaped head.

4. The parallel mechanism according to claim 2, wherein the length of the extending portion is set according to an overall length of the tensile member.

5. The parallel mechanism according to claim 1, wherein
the ball stud is made of steel;
a cup made of resin is installed on inner surfaces of the semispherical recess portion and extending portion of the socket; and
the cup is interposed between the ball-shaped head of the ball stud and both the semispherical recess portion and extending portion of the socket.

6. The parallel mechanism according to claim 5, wherein the resin is a fluorine resin.

7. The parallel mechanism according to claim 1, wherein the extending portion of the socket is arranged to receive a reaction force reacting to a load acting in an axial direction of the rods.

8. The parallel mechanism according to claim 1, wherein the extending portion of the socket is about 0.5 mm in length.
